(19) United States
(12) Patent Application Publication
(10) Pub. No.: US 2012/0195510 A1
(43) Pub. Date: Aug. 2, 2012

(54) INFORMATION PROCESSING APPARATUS, INFORMATION PROCESSING METHOD, AND COMPUTER READABLE MEDIUM

(75) Inventors: Tomoki TANIGUCHI, Kanagawa (JP); Taro YOKOSE, Kanagawa (JP)

(73) Assignee: FUJI XEROX CO., LTD., Tokyo (JP)

(21) Appl. No.: 13/234,334

(22) Filed: Sep. 16, 2011

(30) Foreign Application Priority Data
Feb. 2, 2011 (JP) 2011-020355

(51) Int. Cl. G06K 9/36

(52) U.S. Cl. 382/232

(57) ABSTRACT

An information processing apparatus includes a receiving unit, a separating unit, a first encoding unit, and a second encoding unit. The receiving unit receives information to be encoded. The separating unit separates the information received by the receiving unit into first information and second information on the basis of a predetermined condition. The first encoding unit encodes the first information using a first coding scheme. The second encoding unit encodes the second information using a second coding scheme that is different from the first coding scheme used by the first encoding unit. The first encoding unit encodes the first information using the first coding scheme that is more efficient than the second coding scheme used by the second encoding unit. The second encoding unit encodes the second information using the second coding scheme that is less efficient than the first coding scheme used by the first encoding unit.

### CROSS-REFERENCE TO RELATED APPLICATIONS

This application is based on and claims priority under 35 USC 119 from Japanese Patent Application No. 2011-020355 filed Feb. 2, 2011.

### BACKGROUND

(i) Technical Field

The present invention relates to an information processing apparatus, an information processing method, and a computer readable medium.

(ii) Related Art

Techniques for encoding and decoding information are available.

### SUMMARY

According to an aspect of the invention, there is provided an information processing apparatus including a receiving unit, a separating unit, a first encoding unit, and a second encoding unit. The receiving unit receives information to be encoded. The separating unit separates the information to be encoded, received by the receiving unit, into first information and second information on the basis of a predetermined condition. The first encoding unit encodes the first information, separated by the separating unit, using a first coding scheme. The second encoding unit encodes the second information, separated by the separating unit, using a second coding scheme that is different from the first coding scheme used by the first encoding unit. The first encoding unit encodes the first information using the first coding scheme that is more efficient than the second coding scheme used by the second encoding unit. The second encoding unit encodes the second information using the second coding scheme that is less efficient than the first coding scheme used by the first encoding unit.

### BRIEF DESCRIPTION OF THE DRAWINGS

Exemplary embodiment(s) of the present invention will be described in detail based on the following figures, wherein:

FIG. 1 is a diagram illustrating a conceptual module configuration according to a first exemplary embodiment;

FIG. 2 is a flowchart illustrating an example of a process according to the first exemplary embodiment;

FIG. 3 is a diagram illustrating a conceptual module configuration according to a second exemplary embodiment;

FIG. 4 is a flowchart illustrating an example of a process according to the second exemplary embodiment;

FIG. 5 is a diagram illustrating a conceptual module configuration according to a third exemplary embodiment;

FIG. 6 is a flowchart illustrating an example of a process according to the third exemplary embodiment;

FIGS. 7A to 7C are diagrams illustrating an example of separation performed on JPEG;

FIG. 8 is a diagram illustrating an example of a run-length code;

FIG. 9 is a flowchart illustrating an example of separation processing performed on run-length codes;

FIGS. 10A and 10B are diagrams illustrating examples of run-length codes according to an exemplary embodiment;

FIG. 11 is a flowchart illustrating an example of separation processing involving multiple steps;

FIG. 12 is a diagram illustrating a conceptual module configuration according to a fourth exemplary embodiment;

FIG. 13 is a diagram illustrating a conceptual module configuration according to a fifth exemplary embodiment;

FIG. 14 is a diagram illustrating a conceptual module configuration according to a sixth exemplary embodiment;

FIG. 15 is a diagram illustrating an example of an experiment result based on an exemplary embodiment; and

FIG. 16 is a block diagram illustrating an example of a hardware configuration of a computer that realizes an exemplary embodiment.

### DETAILED DESCRIPTION

To help understanding of exemplary embodiments, techniques that serve as bases of the exemplary embodiments and an overview of the exemplary embodiments will be described first.

As coding schemes (compression schemes), arithmetic coding such as QM-Coder, variable-length coding such as Huffman coding, and fixed-length coding such as fixed run-length encoding (RLE) and uncompressed fixed-length coding are generally used. Since an amount of calculation increases in proportion to a compression ratio, an encoding scheme providing a higher compression ratio requires longer processing time. Meanwhile, to output uncompressed information, i.e., to output information to be encoded as it is without changing the information, is also included as a kind of encoding.

Now, a compression ratio, an encoding speed, a decoding speed of each coding scheme will be compared with each other. Here, “high” indicates that the compression ratio or the speed of processing is higher than those of the other coding schemes, whereas “low” indicates that the compression ratio or the processing speed is lower than those of the other coding schemes. In addition, “intermediate” indicates that the compression ratio or the processing speed is between “high” and “low”.

The arithmetic coding has a “high” compression ratio but has a “low” encoding speed and a “low” decoding speed.

The variable-length coding has an “intermediate” compression ratio, an “intermediate” encoding speed, and an “intermediate” decoding speed.

The fixed-length coding has a “low” compression ratio but has a “high” encoding speed and a “high” decoding speed.

For this reason, the arithmetic coding and the variable-length coding are not generally used when high-speed processing is desired.

The arithmetic coding and the variable-length coding have the encoding speeds or the decoding speeds lower than the fixed-length coding because pieces of information to be encoded that are as long as approximately one bit and eight bits are handled in the arithmetic coding and the variable-length coding in unit time, respectively. That is, in a case of a hardware operation, one bit is processed in the arithmetic coding per clock, whereas eight bits are processed in the variable-length coding per clock. For example, suppose that variable-length coding is performed on four pieces of eight-bit information to be encoded per clock. In this case, processing has to be performed on a 32-bit basis and the number of entries contained in a code table reaches four giga (2³²), which is unrealistic. Accordingly, it is difficult to perform the variable-length coding and the arithmetic coding when N (=one clock/an amount of information to be encoded) is much smaller than one (i.e., N<<1).

Additionally, in fact, the variable-length coding additionally requires variable bit-filling calculation processing and the arithmetic coding further requires status updating processing. For this reason, these coding schemes generally take longer processing time than the fixed-length coding.

In a technique recited in Japanese Unexamined Patent Application Publication No. 2004-135251, compression based on more efficient coding (the arithmetic coding) and compression based on less efficient coding (the variable-length coding) are simultaneously performed. When the more efficient coding does not complete in time, an encoded result of the less efficient coding compensates for an encoded result of the more efficient coding. In this way, both performance regarding the compression processing speed and performance regarding the compression ratio are achieved.

However, it is difficult to achieve both the performance regarding the compression ratio and the performance regarding the processing speed by using general coding schemes. The technique recited in Japanese Unexamined Patent Application Publication No. 2004-135251 can achieve both the performance regarding the compression ratio and the performance regarding the processing speed but requires plural write buffers (N-times more in this case) because information to be encoded has to be compressed based on different coding schemes at the same time.

Since information to be encoded existing in a region (e.g., a micro region) that satisfies a predetermined condition includes a large amount of data, it is difficult to take time for the processing. On the other hand, since a region (e.g., a macro region) that satisfies another predetermined condition includes a small amount of data, processing time hardly affects entire processing time even if the processing takes time.

Accordingly, in exemplary embodiments, information to be encoded is separated based on a predetermined condition (for example, the information to be encoded is separated into information that appears in units of macro regions and information that appears in units of micro regions as described above). The more efficient coding scheme or the less efficient coding scheme is used on each separated piece of the information to be encoded.

Meanwhile, an effect of the more efficient coding is generally low in micro regions because of an effect of noises or the like. Accordingly, a drop of the compression ratio is also small. For example, when more efficient coding (the Huffman coding) and less efficient coding (a technique recited in Japanese Unexamined Patent Application Publication No. 2008-067361) are performed on a micro region, the Huffman coding and the technique recited in Japanese Unexamined Patent Application Publication No. 2008-067361 give a bit rate of 2.45 (bits/pixel) and a bit rate of 2.56 (bits/pixel). Accordingly, a difference between the bit rates is less than 5%. For this reason, an unwanted effect on the compression ratio is small even if the less efficient coding is applied to micro regions.

Various exemplary embodiments for realizing the present invention will be described below on the basis of the attached drawings.

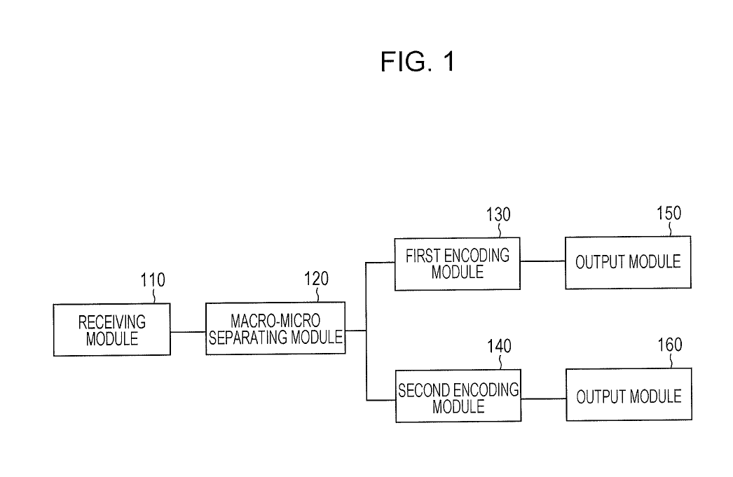

FIG. 1 is a diagram illustrating a conceptual module configuration according to a first exemplary embodiment.

Meanwhile, a module generally indicates a component, such as software (a computer program) or hardware, that can be logically separated from one another. Thus, a module used in exemplary embodiments not only indicates a module in a computer program but also indicates a module in a hardware configuration. For this reason, descriptions of exemplary embodiments include descriptions of a computer program causing a computer to function as those modules (such as a program for causing a computer to execute each procedure, a program for causing a computer to function as each unit, or a program for causing a computer to realize each function), a system, and a method. For ease of explanation, “to store”, “to cause a device to store”, or expressions equivalent thereto are used. When an exemplary embodiment is carried out as a computer program, these expressions indicate that the computer program causes a storage device to store information or the computer program controls a storage device to store information. Additionally, modules and functions may have a one-to-one correspondence. In implementations, one module may be configured by one program, plural modules may be configured by one program, or conversely one module may be configured by plural programs. Additionally, plural modules may be executed by one computer or one module may be executed by plural computers in a distributed or parallel environment. In addition, one module may include another module. Hereinafter, a term “connection” refers to physical connection and logical connection (such as data exchange, reference relations between instructions and between pieces of data). Further, a term “predetermined” refers to a state where something is decided prior to target processing. The term “predetermined” includes the meaning that something is decided in accordance with a state/status at that time or a state/status up to that point before and even after a process according to an exemplary embodiment starts as long as the decision is made prior to the target processing.

Additionally, a system or an apparatus may be constituted by plural computers, plural hardware components, plural devices, and so forth that are connected to each other via communication lines, such as networks (including one-to-one communication connection), or may be realized by one computer, one hardware component, one device, and so forth. The terms “apparatus” and “system” are used as synonyms to each other. Obviously, the “system” does not include a social “mechanism” (social system) that is an arrangement made by humans.

Further, each time each module performs a process or each time a module performs each of plural processes, target information is loaded from a storage device, the process is performed on the target information, and a result of the process is written in the storage device. Accordingly, a description about loading the information from the storage device before the process and writing the result in the storage device after the process may be omitted. Meanwhile, examples of the storage device may include a hard disk, a random access memory (RAM), an external storage medium, a storage device connected via a communication line, registers included in a central processing unit (CPU).

An information processing apparatus according to a first exemplary embodiment is to compress information. As illustrated in FIG. 1, the information processing apparatus includes a receiving module 110, a macro-micro separating module 120, a first encoding module 130, a second encoding module 140, an output module 150, and an output module 160.

The receiving module 110 is connected to the macro-micro separating module 120. The receiving module 110 receives information to be encoded. The information to be encoded is digital data, such as image information, text data, and compressed information such as Joint Photographic Experts Group (JPEG), RLE codes, and prediction codes. To receive information to be encoded includes, for example, to acquire an image with a scanner, a camera, and so forth, to receive an image from an external device via a communication line with a facsimile and so forth, to read out information stored in a hard disk (including the one contained in a computer and the one connected via a network) and so forth, and to receive a result obtained by performing compression on these images. Images may be binary images or multi-valued images (including color images). One image may be received or plural images may be received. Additionally, examples of content of the information include business document or advertizing leaflet.

The macro-micro separating module 120 is connected to the receiving module 110, the first encoding module 130, and the second encoding module 140. The macro-micro separating module 120 separates the information to be encoded that has been received by the receiving module 110 into first information and second information on the basis of a predetermined condition.

Here, the predetermined condition is regarding whether information appears in units of macro regions or information appears in units of micro regions. That is, the first information appears in units of macro regions in the information to be encoded and appearance frequency thereof is lower than that of the second information. On the other hand, the second information appears in units of micro regions in the information to be encoded and appearance frequency thereof is higher than that of the first information.

The macro region indicates a region that is larger than the micro region. Conversely, the micro region indicates a region that is smaller than the macro region. Examples of the information that appears in units of micro regions include information that appears in units of pixels. Examples of the information that appears in units of macro regions include information that appears in units of plural pixels or in units of blocks (e.g., pixels in an 8×8 square).

The first encoding module 130 is connected to the macro-micro separating module 120 and the output module 150. The first encoding module 130 encodes the first information separated by the macro-micro separating module 120 using a more efficient coding scheme than that used by the second encoding module 140. The more efficient coding scheme can achieve a compression ratio that is higher than that of a coding scheme used by the second encoding module 140. Specific examples of the more efficient coding scheme include, for example, the arithmetic coding and the variable-length coding.

The second encoding module 140 is connected to the macro-micro separating module 120 and the output module 160. The second encoding module 140 encodes the second information separated by the macro-micro separating module 120 using a coding scheme different from that of the first encoding module 130. The second encoding module 140 encodes the second information using a less efficient coding scheme than that used by the first encoding module 130. A compression ratio of the less efficient coding scheme may be lower than that of the encoding scheme used by the first encoding module 130. Specific examples of the less efficient coding scheme include, for example, the fixed-length coding.

The output module 150 is connected to the first encoding module 130. The output module 150 outputs a result obtained by the encoding performed by the first encoding module 130.

The output module 160 is connected to the second encoding module 140. The output module 160 outputs a result obtained by the encoding performed by the second encoding module 140.

Outputting performed by the output module 150 and the output module 160 includes, for example, to write the encoded results in a storage device, such as a database, to store the encoded results in a storage medium, such as a memory card, and to supply the encoded results to another information processing apparatus. Meanwhile, examples of an information processing apparatus having a decoding function include, for example, a printing apparatus such as a printer, a display device such as a display, and an image transmitting and receiving apparatus such as a facsimile. To output the encoded results to these apparatuses may indicate to print the encoded results by the printing apparatus, to display the encoded results on the display device, and to send the encoded results to the image transmitting and receiving apparatus.

The output module 150 and the output module 160 separately output the encoded results. When the encoded results are decoded, each of the encoded results may be decoded using a decoding scheme corresponding to the coding scheme thereof and then pieces of information resulting from the decoding may be combined.

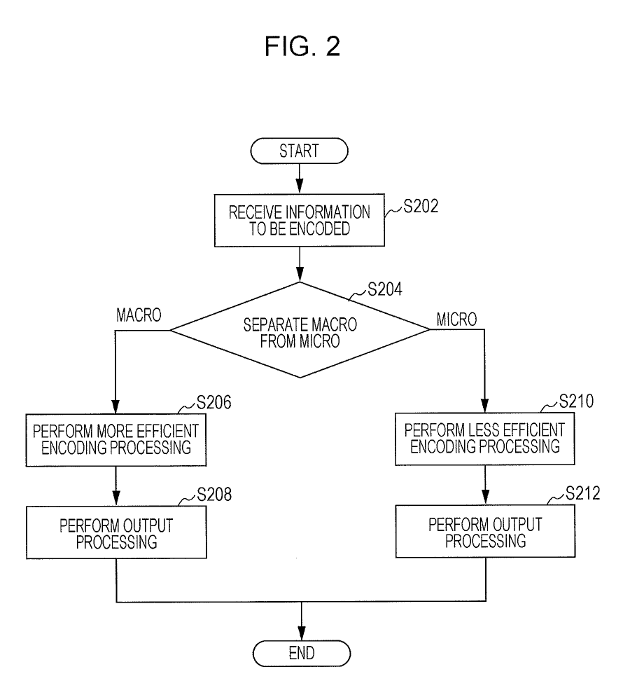

FIG. 2 is a flowchart illustrating an example of a process according to the first exemplary embodiment.

In step S202, the receiving module 110 receives information to be encoded.

In step S204, the macro-micro separating module 120 separates the information to be encoded into macro information (the first information) and micro information (the second information). The process proceeds to step S206 for the macro information, whereas the process proceeds to step S210 for the micro information.

In step S206, the first encoding module 130 performs more efficient encoding processing.

In step S208, the output module 150 performs output processing.

In step S210, the second encoding module 140 performs less efficient encoding processing.

In step S212, the output module 160 performs output processing.

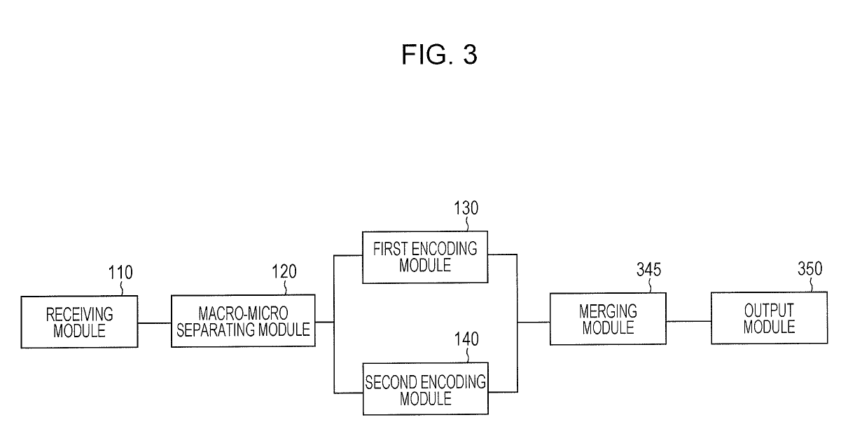

FIG. 3 is a diagram illustrating a conceptual module configuration according to a second exemplary embodiment.

An information processing apparatus according to the second exemplary embodiment is to merge encoded results into one encoded stream. The information processing apparatus includes a receiving module 110, a macro-micro separating module 120, a first encoding module 130, a second encoding module 140, a merging module 345, and an output module 350. Meanwhile, components similar to those described in the foregoing exemplary embodiment are assigned like references to omit a redundant description.

The first encoding module 130 is connected to the macro-micro separating module 120 and the merging module 345, whereas the second encoding module 140 is connected to the macro-micro separating module 120 and the merging module 345.

The merging module 345 is connected to the first encoding module 130, the second encoding module 140, and the output module 350. The merging module 345 merges results obtained by encoding performed by the first encoding module 130 and the second encoding module 140. More specifically, after line-based or band-based encoding processing completes, the merging module 345 interleaves resulting codes to merge them. At this time, in order to prevent alignment of the fixed-length coding from changing, each code may be aligned on boundaries that are multiples of eight bits when being interleaved. An arithmetic code may be initialized each time if needed.

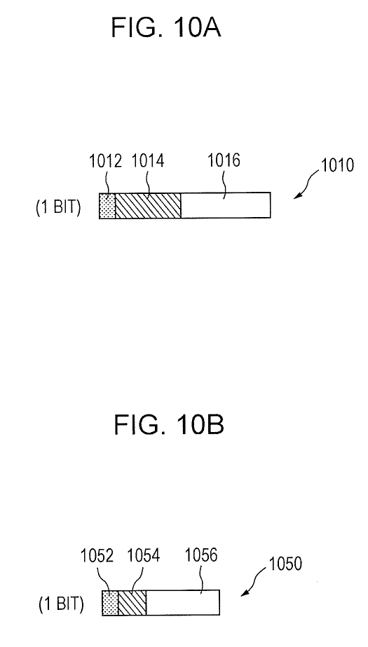

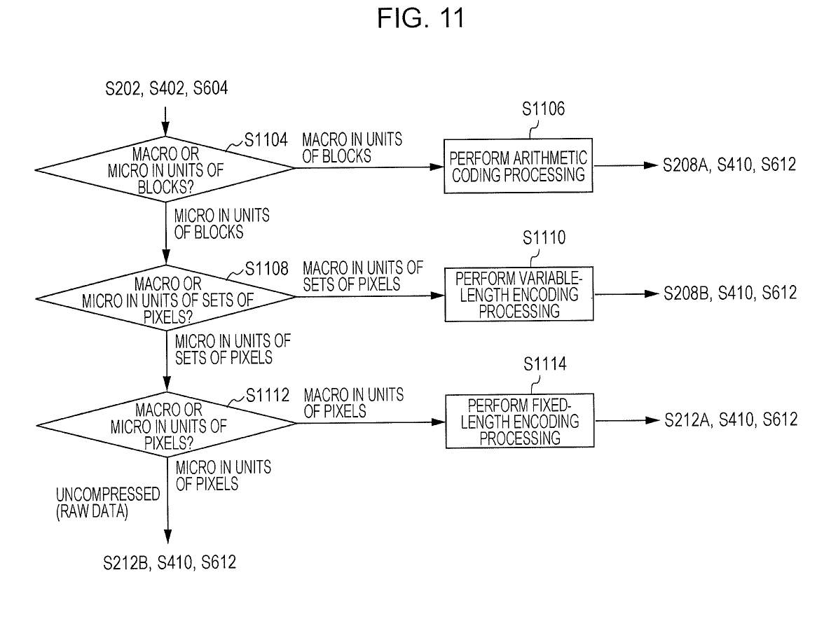

Additionally, the merging module 345 may perform the merging processing by attaching a code, indicating a coding scheme that is used in encoding, to each encoded result. This example will be described later using FIGS. 10A and 10B. When this code is not used, the coding scheme may be estimated from a context in decoding processing.

The output module 350 is connected to the merging module 345. The output module 350 outputs the encoded result obtained from the merging performed by the merging module 345. The output module 350 performs processing similar to that of the output module 150 or the output module 160 according to the first exemplary embodiment.

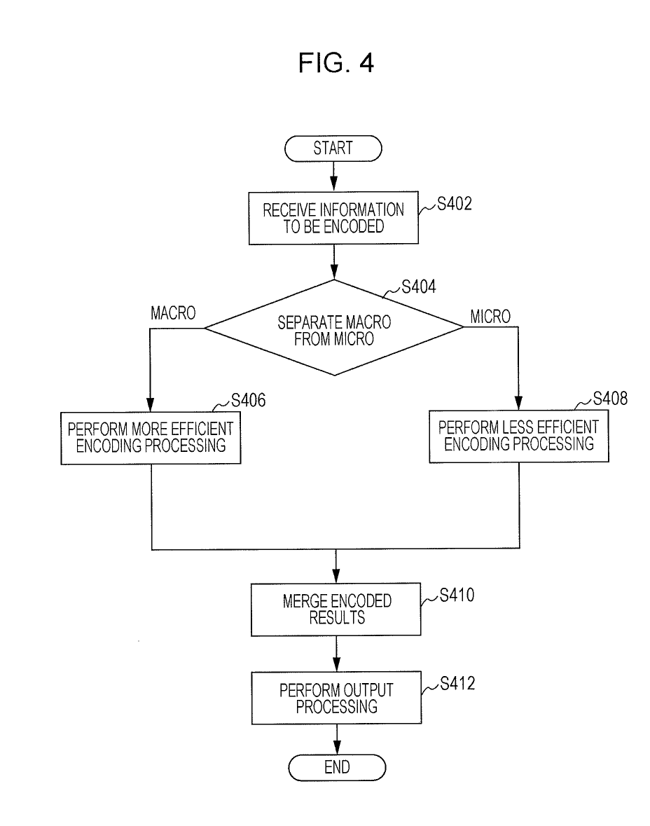

FIG. 4 is a flowchart illustrating an example of a process according to the second exemplary embodiment.

In step S402, the receiving module 110 receives information to be encoded.

In step S404, the macro-micro separating module 120 separates the information to be encoded into macro information and micro information. The process proceeds to step S406 for the macro information, wherein the process proceeds to step S408 for the micro information.

In step S406, the first encoding module 130 performs more efficient encoding processing.

In step S408, the second encoding module 140 performs less efficient encoding processing.

In step S410, the merging module 345 merges encoded results.

In step S412, the output module 350 performs output processing.

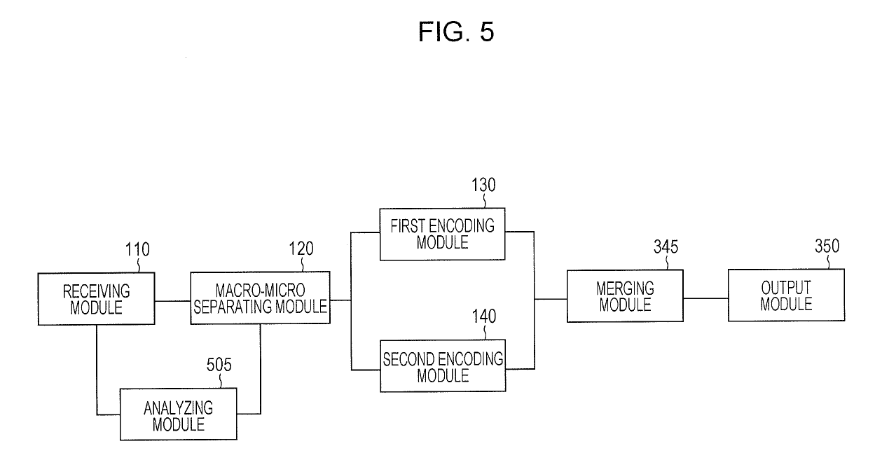

FIG. 5 is a diagram illustrating a conceptual module configuration according to a third exemplary embodiment.

An information processing apparatus according to a third exemplary embodiment is to analyze information to be encoded and to separate the information to be encoded using this analysis result. The information processing apparatus includes a receiving module 110, a macro-micro separating module 120, an analyzing module 505, a first encoding module 130, a second encoding module 140, a merging module 345, and an output module 350.

This configuration is equivalent to the configuration according to the second exemplary embodiment illustrated in FIG. 3 additionally including the analyzing module 505. The analyzing module 505 may be added to the configuration according to the first exemplary embodiment illustrated in FIG. 1. More specifically, the analyzing module 505 may be arranged to be connected to the receiving module 110 and the macro-micro separating module 120 illustrated in FIG. 1.

The receiving module 110 is connected to the macro-micro separating module 120 and the analyzing module 505. The macro-micro separating module 120 is connected to the receiving module 110, the analyzing module 505, the first encoding module 130, and the second encoding module 140.

The analyzing module 505 is connected to the receiving module 110 and the macro-micro separating module 120. The analyzing module 505 analyzes information to be encoded that has been received by the receiving module 110. For example, in a coding scheme using the number of coding prediction errors, the number of coding prediction errors alters depending on the information to be encoded. The analyzing module 505 analyzes the information to be encoded to extract the number of coding prediction errors and then supplies the determined number of coding prediction errors to the macro-micro separating module 120.

The macro-micro separating module 120 performs separation on the basis of the result of the analysis performed by the analyzing module 505. For example, the macro-micro separating module 120 may perform separation so that the information to be encoded is supplied to the first encoding module 130 or the second encoding module 140 depending on the number of coding prediction errors.

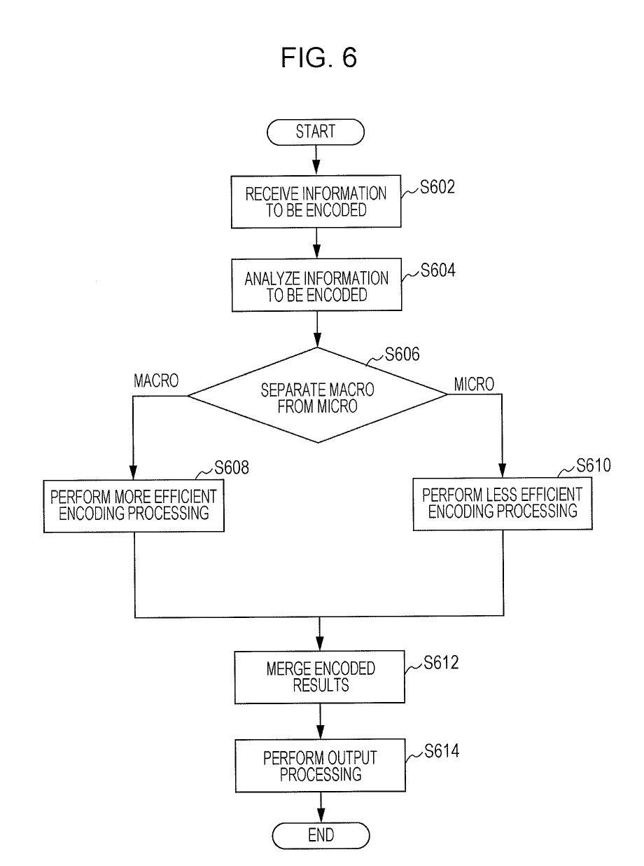

FIG. 6 is a flowchart illustrating an example of a process according to the third exemplary embodiment.

In step S602, the receiving module 110 receives information to be encoded.

In step S604, the analyzing module 505 analyzes the information to be encoded.

In step S606, the macro-micro separating module 120 separates the information to be encoded into macro information and micro information. The process proceeds to step S608 for the macro information, whereas the process proceeds to step S610 for the micro information.

In step S608, the first encoding module 130 performs more efficient encoding processing.

In step S610, the second encoding module 140 performs less efficient encoding processing.

In step S612, the merging module 345 merges encoded results.

In step S614, the output module 350 performs output processing.

Now, an example will be illustrated in which information of transform coding (JPEG) is handled as the information to be encoded that is received by the receiving module 110 in the first to third exemplary embodiments. This example illustrates a processing example performed by the macro-micro separating module 120.

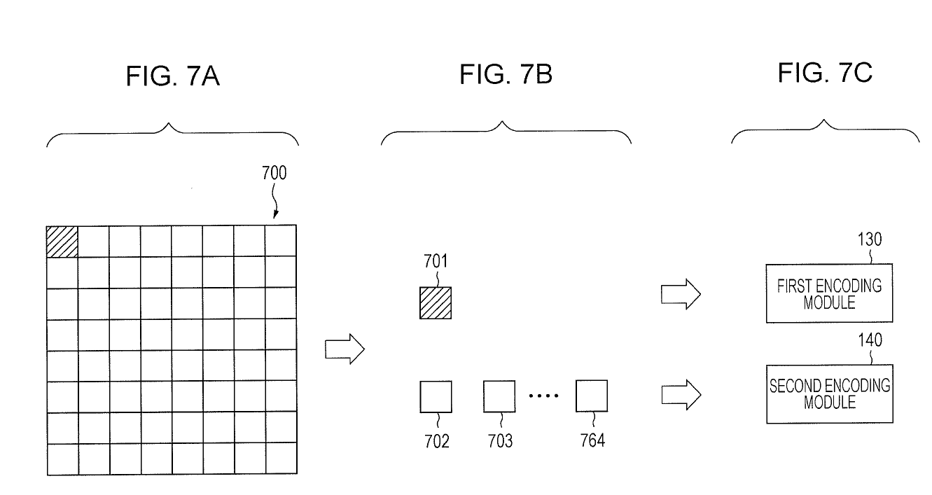

FIGS. 7A to 7C illustrate a JPEG separation example. In discrete cosine transform (DCT) in JPEG, variable-length coding is performed on DCT coefficients, which is one-dimensional information resulting from zigzag scan. The DCT coefficients include one direct current (DC) value (an upper left value in a two-dimensional DCT coefficients 700 and a DC component 701 illustrated in FIG. 7B) and 63 alternate current (AC) values (values other than the upper left value in the two-dimensional DCT coefficients 700 and AC components 702 to 764 illustrated in FIG. 7B) in a block (of 8×8 pixels and the two-dimensional DCT coefficients 700 illustrated in FIG. 7A). As illustrated in FIG. 7C, the first encoding module 130 performs the variable-length coding on the DC value (the DC component 701) that appears in units of macro regions, whereas the second encoding module 140 performs fixed-length RLE on the AC values (the AC components 702 to 764) that appear in units of micro regions. Since runs of zero are observed for most JPEG AC components, a high compression ratio can be expected even for the fixed RLE.

Meanwhile, the variable-length coding may be replaced by the arithmetic coding. At that time, the RLE may be replaced by the variable-length coding. The coding schemes to be used may be decided in accordance with target processing time.

Now, an example will be illustrated in which information of the RLE is handled as the information to be encoded that is received by the receiving module 110 in the first to third exemplary embodiments. This example illustrates a processing example performed by the macro-micro separating module 120.

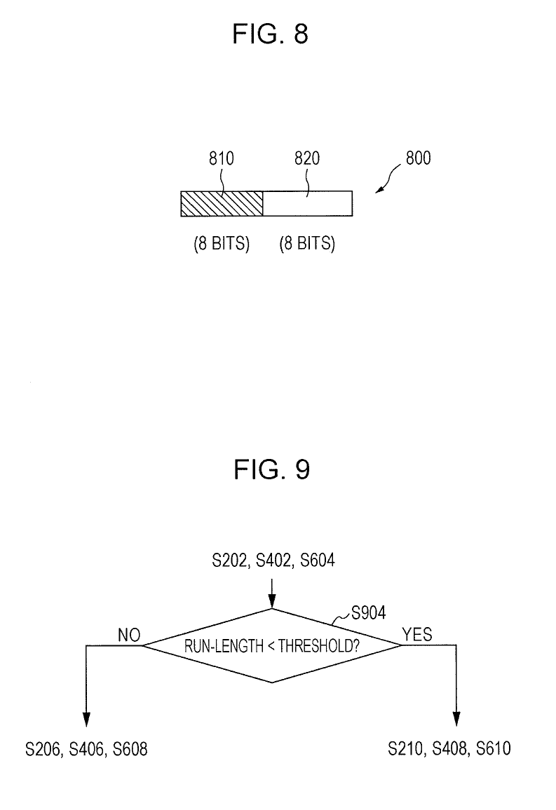

FIG. 8 is a diagram illustrating an example of a run-length code. In RLE (the fixed RLE herein), the number of matching neighboring pixels (hereinafter, run-length) and a value of the matching pixels are encoded. Accordingly, a run-length code 800 includes a run-length part 810 and a pixel-value part 820. Generally, each of the run-length part 810 and the pixel-value part 820 has a fixed length, i.e., eight bits.

Since the run-length is encoded each time a run of matching pixels is interrupted, the length of the run of the matching pixels can be considered as encoding units of the information to be encoded. FIG. 9 is a flowchart illustrating an example of separation processing performed on run-length codes. Step S904 corresponds to step S204 of the flowchart illustrated in FIG. 2, step S404 of the flowchart illustrated in FIG. 4, or step S606 of the flowchart illustrated in FIG. 6. In step S904, whether or not the run-length is smaller than a threshold (run-length<threshold) is determined. When the run-length is smaller than the threshold (micro information), the process proceeds to step S210, S408, or S610. Otherwise (macro information), the process proceeds to step S206, S406, or S608. More specifically, fixed-length coding is used on a code (including the run-length part and the pixel-value part) having the run-length that is smaller than the predetermined threshold, whereas variable-length coding is used on a code (including the run-length part and the pixel-value part) having the run-length that is not smaller than the predetermined threshold. In this case, the compression ratio of the RLE may be improved since some of the run-length codes, all of which originally have a fixed length (see FIG. 8), can have variable lengths. FIGS. 10A and 10B illustrate examples of run-length codes. As illustrated in FIG. 10A, a run-length code 1010 resulting from the fixed-length coding includes a code identification part 1012, a run-length part (fixed length) 1014, and a pixel-value part (fixed length) 1016. The run-length code 1010 is equivalent to the run-length code 800 illustrated in FIG. 8 that additionally includes the code identification part 1012. As illustrated in FIG. 10B, a run-length code 1050 resulting from the variable-length coding includes a code identification part 1052, a run-length part (variable length) 1054, and a pixel-value part (variable length) 1056. Although the run-length codes are categorized into two kinds here, the run-length codes may be categorized into three or more kinds using two or more predetermined thresholds.

One-bit code (the code identification part 1012 or the code identification part 1052) indicating which of the fixed-length coding and the variable-length coding is used is attached in the processing performed by the merging module 345. Additionally, the one-bit identification information may be included in another stream. When the identification information is included in another stream, misalignment does not occur in the fixed-length codes.

Now, an example will be illustrated in which information of predictive coding is handled as the information to be encoded that is received by the receiving module 110 in the first to third exemplary embodiments. This example illustrates a processing example performed by the macro-micro separating module 120.

A compression scheme is available in which prediction modes are switched between in units of blocks (e.g., of 4×4 pixels). Information to be encoded in this scheme at least includes the prediction mode and a prediction error value. This example case is similar to that described above for transform coding (JPEG). More specifically, a mode that occurs in units of blocks (macro information) is subjected to the variable-length coding, whereas an error that occurs in units of pixels (micro information) is subjected to the fixed-length coding.

An example of separation processing involving multiple steps according to the first to third exemplary embodiments will be illustrated next. FIG. 11 is a flowchart illustrating an example of the separation processing involving multiple steps. A set of steps S1104, S1108, and S1112 corresponds to step S204 of the flowchart illustrated in FIG. 2, step S404 of the flowchart illustrated in FIG. 4, or step S606 of the flowchart illustrated in FIG. 6.

In step S1104, determination is performed for each block. If it is determined that the information is macro information in units of blocks (if the information occurs in units of blocks), the process proceeds to step S1106. If the information is micro information in units of blocks, the process proceeds to step S1108.

In step S1106, the arithmetic coding is performed.

In step S1108, determination is performed for every several pixels. If the information is macro information in units of sets of several pixels (if the information occurs in units of sets of several pixels), the process proceeds to step S1110. If the information is micro information in units of sets of several pixels, the process proceeds to step S1112.

In step S1110, the variable-length coding is performed.

In step S1112, determination is performed in units of pixels. If the information is macro information in units of pixels (if the information occurs in units of pixels), the process proceeds to step S1114. If the information is micro information in units of pixels, the process proceeds to step S212B, S410, or S612.

In step S1114, the fixed-length coding is performed.

Meanwhile, in steps S208A and S208B, processing similar to that in step S208 of the flowchart illustrated in FIG. 2 is performed. Additionally, in steps S212A and S212B, processing similar to that in step S212 of the flowchart illustrated in FIG. 2 is performed.

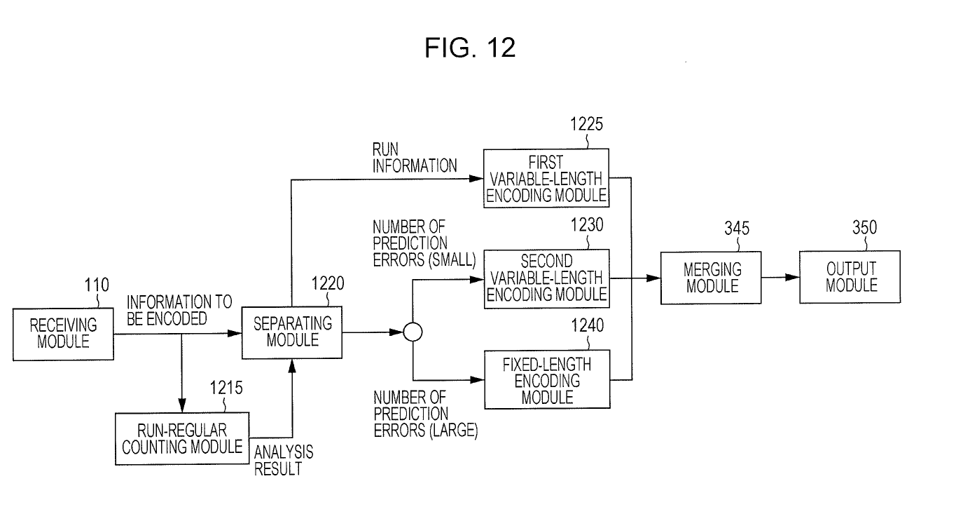

FIG. 12 is a diagram illustrating a conceptual module configuration according to a fourth exemplary embodiment.

An information processing apparatus according to the fourth exemplary embodiment includes a receiving module 110, a run-regular counting module 1215, a separating module 1220, a first variable-length coding module 1225, a second variable-length coding module 1230, a fixed-length coding module 1240, a merging module 345, and an output module 350. This configuration includes a specific configuration of the analyzing module 505 according to the third exemplary embodiment illustrated in FIG. 5. A first example is illustrated in which JPEG-LS information is handled as the information to be encoded that is received by the receiving module 110.

JPEG-LS is a scheme in which a run mode and a regular mode are switched between in accordance with a context of surrounding pixels. Runs are encoded in the run mode, whereas errors are encoded in the regular mode. Accordingly, codewords are assigned in the run mode in units of runs (one to tens of pixels) and in the regular mode in units of errors (pixels). Thus, it is estimated that the regular mode restricts the processing speed. Meanwhile, in JPEG-LS, contexts are sorted into 720 types on the basis of gradation of values of pixels surrounding a target pixel.

The receiving module 110 is connected to the run-regular counting module 1215 and the separating module 1220. The receiving module 110 receives information to be encoded and supplies the information to the run-regular counting module 1215 and the separating module 1220.

The run-regular counting module 1215 is connected to the receiving module 110 and the separating module 1220. The run-regular counting module 1215 analyzes JPEG-LS information, i.e., the information to be encoded, and supplies the analysis result to the separating module 1220. More specifically, the run-regular counting module 1215 counts the number of pixels to be encoded in the regular mode in the first path.

The separating module 1220 is connected to the receiving module 110, the run-regular counting module 1215, the first variable-length encoding module 1225, the second variable-length encoding module 1230, and the fixed-length encoding module 1240. The separating module 1220 supplies run information to the first variable-length encoding module 1225, supplies prediction errors to the second variable-length encoding module 1230 when the number of prediction errors is small, and also supplies the prediction errors to the fixed-length encoding module 1240 when the number of prediction errors is large. More specifically, in the run mode, the separating module 1220 supplies the run information to the first variable-length encoding module 1225. When the number of prediction errors to be processed in the regular mode exceeds a predetermined threshold, the separating module 1220 supplies the prediction errors to the fixed-length encoding module 1240 in order to replace the prediction errors based on the fixed-length coding in the regular mode. Otherwise, the separating module 1220 supplies the prediction errors to the second variable-length encoding module 1230.

The first variable-length encoding module 1225 is connected to the separating module 1220 and the merging module 345. The first variable-length encoding module 1225 encodes the run information using a variable-length coding scheme.

The second variable-length encoding module 1230 is connected to the separating module 1220 and the merging module 345. The second variable-length encoding module 1230 encodes the prediction errors using a variable-length encoding scheme.

The fixed-length encoding module 1240 is connected to the separating module 1220 and the merging module 345. The fixed-length encoding module 1240 encodes the prediction errors using a fixed-length coding scheme.

The merging module 345 is connected to the first variable-length encoding module 1225, the second variable-length encoding module 1230, the fixed-length encoding module 1240, and the output module 350. Information about which of the fixed-length coding and the variable-length coding is used may be included in a code or may be estimated on a decoding side.

The output module 350 is connected to the merging module 345.

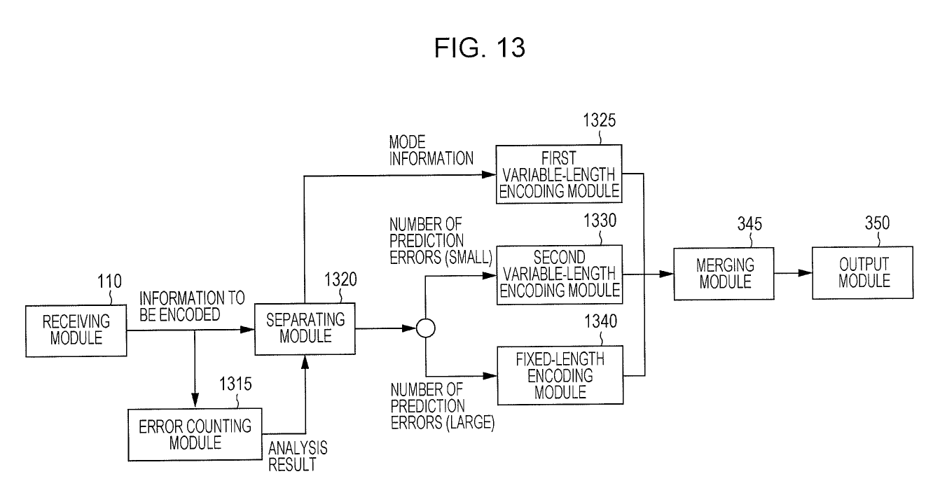

FIG. 13 is a diagram illustrating a conceptual module configuration according to a fifth exemplary embodiment.

An information processing apparatus according to the fifth exemplary embodiment includes a receiving module 110, an error counting module 1315, a separating module 1320, a first variable-length encoding module 1325, a second variable-length encoding module 1330, a fixed-length encoding module 1340, a merging module 345, and an output module 350. This configuration includes a specific configuration of the analyzing module 505 according to the third exemplary embodiment illustrated in FIG. 5. An example in which information of predictive coding is handled as information to be encoded that is received by the receiving module 110.

The number of prediction errors differs depending on images. Generally, a large number of prediction errors occur in photos, whereas a small number of prediction errors occur in computer graphics (CG). Since prediction errors occur in units of pixels and generally undergo variable-length coding, the variable-length coding restricts the processing speed.

The receiving module 110 is connected to the error counting module 1315 and the separating module 1320. The receiving module 110 receives information to be encoded and supplies the information to the error counting module 1315 and the separating module 1320.

The error counting module 1315 is connected to the receiving module 110 and the separating module 1320. The error counting module 1315 analyzes information about prediction errors, i.e., the information to be encoded, and supplies the analysis result to the separating module 1320.

The separating module 1320 is connected to the receiving module 110, the error counting module 1315, the first variable-length encoding module 1325, the second variable-length encoding module 1330, and the fixed-length encoding module 1340. The separating module 1320 supplies mode information to the first variable-length encoding module 1325, supplies the prediction errors to the variable-length encoding module 1330 when the number of prediction errors is small, and supplies the prediction errors to the fixed-length encoding module 1340 when the number of prediction errors is large. More specifically, the separating module 1320 supplies the mode information to the first variable-length encoding module 1325. When the number of prediction errors exceeds a predetermined threshold, the separating module 1320 supplies the prediction errors to the fixed-length encoding module 1340. Otherwise, the separating module 1320 supplies the prediction errors to the variable-length encoding module 1330.

The first variable-length encoding module 1325 is connected to the separating module 1320 and the merging module 345. The first variable-length encoding module 1325 encodes the mode information using a variable-length coding scheme.

The second variable-length encoding module 1330 is connected to the separating module 1320 and the merging module 345. The second variable-length encoding module 1330 encodes the prediction errors using a variable-length coding scheme.

The fixed-length encoding module 1340 is connected to the separating module 1320 and the merging module 345. The fixed-length encoding module 1340 encodes the prediction errors using a fixed-length coding scheme.

The merging module 345 is connected to the first variable-length encoding module 1325, the second variable-length encoding module 1330, the fixed-length encoding module 1340, and the output module 350. Information about the used coding scheme may be included in header information or a decoding side may determine the used coding scheme by performing a calculation each time.

The output module 350 is connected to the merging module 345.

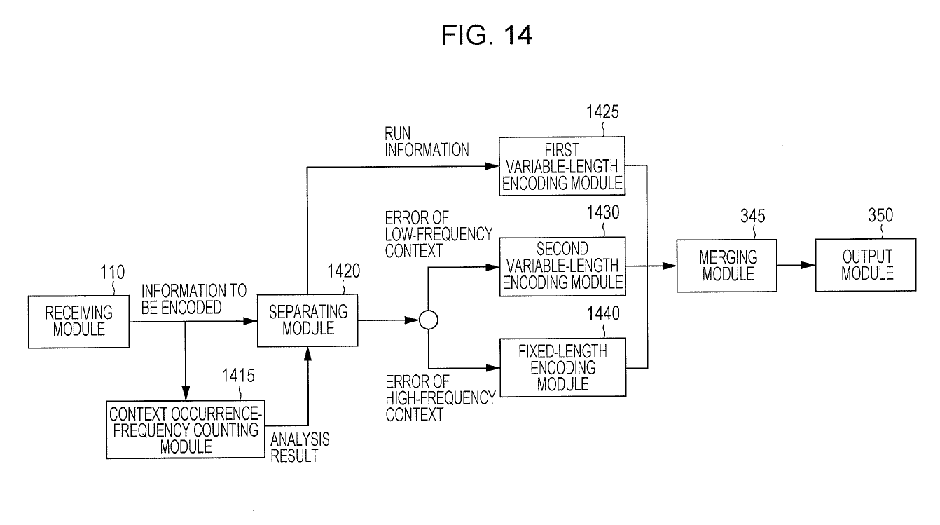

FIG. 14 is a diagram illustrating a conceptual module configuration according to a sixth exemplary embodiment.

An information processing apparatus according to the sixth exemplary embodiment includes a receiving module 110, a context occurrence-frequency counting module 1415, a separating module 1420, a first variable-length encoding module 1425, a second variable-length encoding module 1430, a fixed-length encoding module 1440, a merging module 345, and an output module 350. This configuration includes a specific configuration of the analyzing module 505 according to the third exemplary embodiment illustrated in FIG. 5. A second example is illustrated in which JPEG-LS information is handled as information to be encoded that is received by the receiving module 110.

In JPEG-LS, the number of times a context occurs differs depending on images. Accordingly, the number of times the context occurs is counted in the first path and different coding schemes may be used depending on the counted value. Additionally, this exemplary embodiment may be used in combination with the fourth exemplary embodiment.

The receiving module 110 is connected to the context occurrence-frequency counting module 1415 and the separating module 1420. The receiving module 110 receives information to be encoded and supplies the information to the context occurrence-frequency counting module 1415 and the separating module 1420.

The context occurrence-frequency counting module 1415 is connected to the receiving module 110 and the separating module 1420. The context occurrence-frequency counting module 1415 analyzes JPEG-LS information, i.e., the information to be encoded, and supplies the analysis result to the separating module 1420. More specifically, the context occurrence-frequency counting module 1415 counts the number of times a context occurs in the first path.

The separating module 1420 is connected to the receiving module 110, the context occurrence-frequency counting module 1415, the first variable-length encoding module 1425, the second variable-length encoding module 1430, and the fixed-length encoding module 1440. The separating module 1420 supplies run information to the first variable-length encoding module 1425, supplies an error of a context having a low occurrence frequency to the second variable-length encoding module 1430, and supplies an error of a context having a high occurrence frequency to the fixed-length encoding module 1440. More specifically, in a run mode, the separating module 1420 supplies the run information to the first variable-length encoding module 1425. If the occurrence frequency of the context is higher than a predetermined threshold, the separating module 1420 supplies prediction errors of the context to the fixed-length encoding module 1440. Otherwise, the separating module 1420 supplies the prediction errors to the second variable-length encoding module 1430.

The first variable-length encoding module 1425 is connected to the separating module 1420 and the merging module 345. The first variable-length encoding module 1425 encodes the run information using a variable-length coding scheme.

The second variable-length encoding module 1430 is connected to the separating module 1420 and the merging module 345. The second variable-length encoding module 1430 encodes the prediction errors using a variable-length coding scheme.

The fixed-length encoding module 1440 is connected to the separating module 1420 and the merging module 345. The fixed-length encoding module 1440 encodes the prediction errors using a fixed-length coding scheme.

The merging module 345 is connected to the first variable-length encoding module 1425, the second variable-length encoding module 1430, the fixed-length encoding module 1440, and the output module 350.

The output module 350 is connected to the merging module 345.

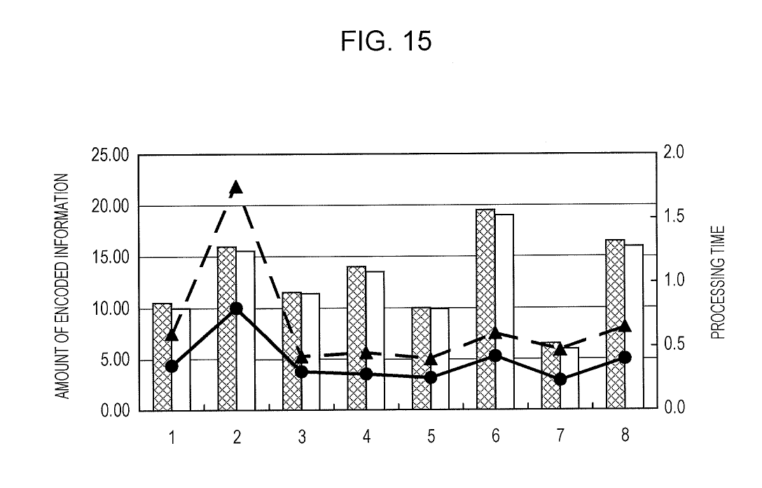

FIG. 15 is a diagram illustrating an example of an experiment result according to an exemplary embodiment.

A check is performed using the aforementioned case of the predictive coding. A horizontal axis of a graph illustrated in FIG. 15 represents a target sample number, whereas a left vertical axis and a right vertical axis represent an amount of encoded information and processing time, respectively. A shaded rectangular bar on the left side indicates an amount of information encoded according to the exemplary embodiment, whereas a plane rectangular bar on the right side indicates an amount of information encoded according to the related art. A solid line indicates processing time according to the exemplary embodiment, whereas a broken line indicates processing time according to the related art. This example reveals that processing time is improved with the amount of encoded information being maintained.

Meanwhile, as the second encoding module 140 that uses a fixed-length coding scheme, following encoding modules may be used.

1) An encoding module includes a group generating module that puts plural information values to be encoded together and generates a group of information values to be encoded, a code assignment module that assigns a code to each group generated by the group generating module, and an information encoding module that encodes the information values to be encoded belonging to each group, using the code assigned to the group.

2) In the encoding module recited in 1), the group generating module puts the plural information values to be encoded together and generates a lower-order group of information values to be encoded. The encoding module further includes a group sorting module that sorts a lower-order group generated by the group generating module to a higher-order group. The code assignment module assigns a code to the higher-order group. The information encoding module encodes the information values to be encoded of a lower-order group belonging to the same higher-order group, using a variable length code assigned to the higher-order group.

3) In the encoding module recited in 2), the group generating module puts every predetermined number of information values to be encoded, which have been input, together in order of input and generates a lower-order group containing the predetermined number of information values to be encoded. The group sorting module sorts the lower-order group to a higher-order group, based on the numbers of bits to represent, respectively, the information values to be encoded belonging to the lower-order group.

4) In the encoding module recited in 1), the code assignment module assigns an entropy code to each group, according to the probability of appearance of each group.

5) The encoding module recited in 1), further includes an information converting module that converts each of input information values to be encoded to a value represented in a string of bits fewer than the bits of the original information value to be encoded. The information encoding module encodes the information values to be encoded belonging to each group, using bit strings converted by the information converting module and a code assigned to the group.

6) The encoding apparatus recited in 1), further includes a table-use encoding module that encodes the group of information values to be encoded using a code table showing linkage between plural information values which can be contained in the group and code data of these information values, and a directing module that directs the group of information values generated by the group generating module to a combination of the code assignment module and the information encoding module, or to the table-use encoding module. The code assignment module assigns a code to the group directed by the directing module. The information encoding module encodes the information values to be encoded of the group directed by the directing module.

A decoding module for the encoding modules recited in 1) to 6) has a configuration recited in 7) below.

7) A decoding module includes a code length parsing module that, for a group including plural encoded information values, parses code length of each of the encoded information values belonging to the group, based on a code assigned to the group, and an encoded information decoding module that decodes the encoded information values belonging to the group, based on the code length of each encoded information value parsed by the code length parsing module.

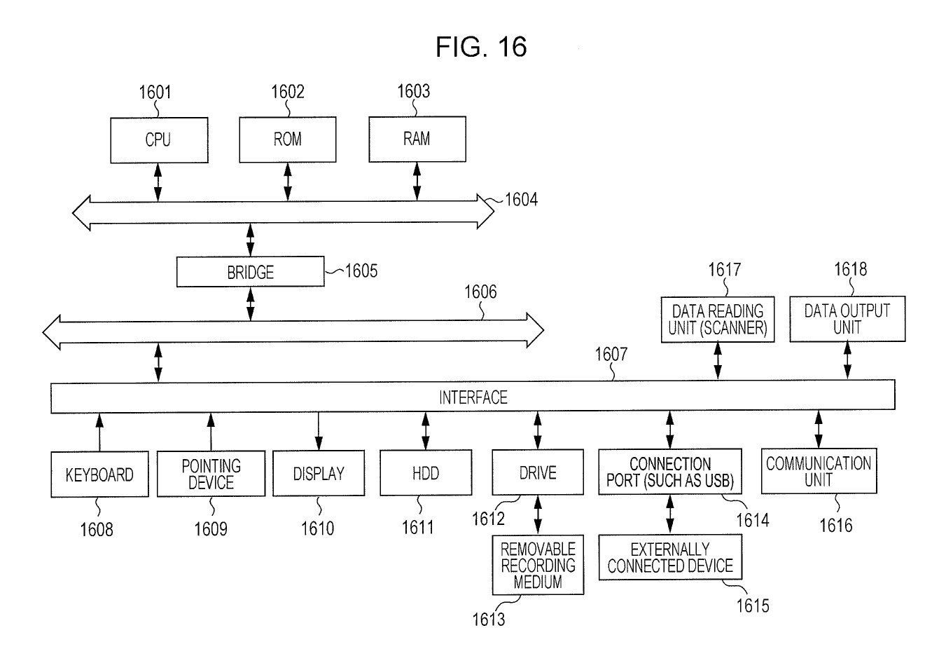

An example of a hardware configuration of an information processing apparatus according to an exemplary embodiment will be described with reference to FIG. 16. The configuration illustrated in FIG. 16 is constituted by, for example, a personal computer (PC) or the like. FIG. 16 illustrates an example hardware configuration including a data reading unit 1617, such as a scanner, and a data output unit 1618, such as a printer.

A central processing unit (CPU) 1601 is a controller that executes processing in accordance with a computer program containing an execution sequence of each of the various modules, i.e., the receiving module 110, the macro-micro separating module 120, the first encoding module 130, the second encoding module 140, the merging module 345, the output module 350, the analyzing module 505, the run-regular counting module 1215, the separating module 1220, the first variable-length encoding module 1225, the second variable-length encoding module 1230, the fixed-length encoding module 1240, the error counting module 1315, the context occurrence-frequency module 1415, that have been described in the foregoing exemplary embodiments.

A read only memory (ROM) 1602 stores programs, calculation parameters, and so forth used by the CPU 1601. A random access memory (RAM) 1603 stores programs executed by the CPU 1601, parameters that change during the execution, and so forth. The CPU 1601, the ROM 1602, and RAM 1603 are connected to each other via a host bus 1604, such as a CPU bus.

The host bus 1604 is connected to an external bus 1606, such as a peripheral component interconnect/interface (PCI) bus, via a bridge 1605.

A keyboard 1608 and a pointing device 1609, such as a mouse, are input devices that are operated by operators. A display 1610, such as a liquid crystal display (LCD) or a cathode ray tube (CRT), displays various information as text information and image information.

A hard disk drive (HDD) 1611 includes a hard disk therein and drives the hard disk to record or reproduce programs executed by the CPU 1601 and information. Data, such as received images to be encoded and results of encoding processing, may be stored on the hard disk. Various computer programs, such as various data processing programs, are further stored on the hard disk.

A drive 1612 reads out data or programs recorded on a removable recording medium 1613 inserted thereto, such as a magnetic disk, an optical disc, a magneto-optical disk, or a semiconductor memory and supplies the data or the programs to the RAM 1603 connected thereto via an interface 1607, the external bus 1606, the bridge 1605, and the host bus 1604. The removable recording medium 1613 can be utilized as a data recording area similar to the hard disk.

A connection port 1614, such as a universal serial bus (USB) or IEEE 1394, is a port to which an externally connected device 1615 is connected. The connection port 1614 is connected to the CPU 1601 and so forth via the interface 1607, the external bus 1606, the bridge 1605, and the host bus 1604. A communication unit 1616 is connected to a network and executes data communication with external devices. The data reading unit 1617, such as a scanner, scans a document. The data output unit 1618, such as a printer, outputs document data.

The hardware configuration of the information processing apparatus illustrated in FIG. 16 shows merely one configuration example. The exemplary embodiments are not limited to the configuration illustrated in FIG. 16 and any configuration may be used as long as the configuration can carry out the modules described in the exemplary embodiments. For example, some modules may be configured by dedicated hardware (e.g., an application specific integrated circuit (ASIC)) and some modules may resides in an external system and may be connected to other modules via a communication line. Further, plural systems illustrated in FIG. 16 may be connected to each other via a communication line and may be configured to operate in cooperation with each other. Additionally, the system illustrated in FIG. 16 may be incorporated into a copier, a facsimile, a scanner, a printer, and a multifunction peripheral (an image processing apparatus having two or more functions, such as of a scanner, a printer, a copier, and a facsimile).

The aforementioned various exemplary embodiments may be used in combination (for example, including to add a module according to one exemplary embodiment in another exemplary embedment, and to replace a module according to one exemplary embodiment by another module according to another exemplary embedment). Additionally, techniques described as the related art may be adopted in processing content of each module.

Meanwhile, the above-described programs may be provided after being stored on a recording medium or may be provided via a communication network. In this case, for example, the above-described programs may be considered as an invention regarding “a computer readable recoding medium storing a program”.

The “computer readable recording medium storing a program” is used for installation, execution, and distribution of the program.

Examples of the recoding medium include a digital versatile disc (DVD), such as “DVD-R, DVD-RW, or DVD-RAM” based on a standard developed by the DVD forum or “DVD+R or DVD+RW” based on a standard developed by the DVD+RW; a compact disc (CDs), such as CD read only memory (CD-ROM), a CD recordable (CD-R), or a CD rewritable (CD-RW); a blu-ray disc (registered trademark); a magneto-optical disc (MO); a flexible disc (FD); a magnetic tape; a hard disk; a read only memory (ROM); an electrically erasable programmable read only memory (EEPROM (registered trademark)); a flash memory; and a random access memory (RAM).

The aforementioned program or part of the program may be stored and distributed after being recorded on the recoding medium. Alternatively, the program or part of the program may be transmitted by communication using a transmission medium such as a wired or wireless network used in a local area network (LAN), a metropolitan area network (MAN), a wide area network (WAN), the Internet, an intranet, an extranet, and so forth, and further a combination of the wired and wireless networks, or may be transmitted over carrier waves.

Furthermore, the aforementioned program may be part of another program or may be recorded on a recoding medium together with another program. Additionally, the program may be recorded on plural recording media in a distributed manner, or may be recorded in any manner, such as being compressed or being encrypted, as long as the program can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives information to be encoded;
a separating unit that separates the information to be encoded, received by the receiving unit, into first information and second information on the basis of a predetermined condition;
a first encoding unit that encodes the first information, separated by the separating unit, using a first coding scheme; and
a second encoding unit that encodes the second information, separated by the separating unit, using a second coding scheme that is different from the first coding scheme used by the first encoding unit,
wherein the first encoding unit encodes the first information using the first coding scheme that is more efficient than the second coding scheme used by the second encoding unit, and
wherein the second encoding unit encodes the second information using the second coding scheme that is less efficient than the first coding scheme used by the first encoding unit.

2. The information processing apparatus according to claim 1, further comprising:
a merging unit that merges encoded results obtained by the encoding performed by the first encoding unit and by the second encoding unit.

3. The information processing apparatus according to claim 2, wherein the merging unit attaches a code to an encoded result when merging the encoded results, the code indicating one of the coding schemes that has been used in the encoding.

4. The information processing apparatus according to claim 1, further comprising:
an analyzing unit that analyzes the information to be encoded, received by the receiving unit,
wherein the separating unit separates the information to be encoded on the basis of a result of the analysis performed by the analyzing unit.

5. The information processing apparatus according to claim 2, further comprising:
an analyzing unit that analyzes the information to be encoded, received by the receiving unit,
wherein the separating unit separates the information to be encoded on the basis of a result of the analysis performed by the analyzing unit.

6. The information processing apparatus according to claim 3, further comprising:
an analyzing unit that analyzes the information to be encoded, received by the receiving unit,
wherein the separating unit separates the information to be encoded on the basis of a result of the analysis performed by the analyzing unit.

7. An information processing method comprising:
receiving information to be encoded;
separating the received information to be encoded into first information and second information on the basis of a predetermined condition;
encoding the first information using a first coding scheme; and
encoding the second information using a second coding scheme that is different from the first coding scheme,
wherein the first information is encoded using the first coding scheme that is more efficient than the second coding scheme, and
wherein the second information is encoded using the second coding scheme that is less efficient than the first coding scheme.

8. A computer readable medium storing a program causing a computer to execute a process for information processing, the process comprising:
receiving information to be encoded;
separating the received information to be encoded into first information and second information on the basis of a predetermined condition;
encoding the first information using a first coding scheme; and
encoding the second information using a second coding scheme that is different from the first coding scheme,
wherein the first information is encoded using the first coding scheme that is more efficient than the second coding scheme, and
wherein the second information is encoded using the second coding scheme that is less efficient than the first coding scheme.
